(19) United States
(12) Patent Application Publication
(10) Pub. No.: US 2021/0384538 A1
(43) Pub. Date: Dec. 9, 2021

(54) ELECTRIC POWER ADJUSTMENT SYSTEM, ELECTRIC POWER ADJUSTMENT METHOD, AND STORAGE MEDIUM

(71) Applicant: HONDA MOTOR CO., LTD., Tokyo (JP)

(72) Inventors: Masahiro Mohri, Wako-shi (JP); Shuichi Kazuno, Wako-shi (JP); Takashi Arai, Wako-shi (JP)

(21) Appl. No.: 17/337,487

(22) Filed: Jun. 3, 2021

(30) Foreign Application Priority Data
Jun. 5, 2020 (JP) 2020-098562

(51) Int. Cl. H01M 8/0656; H01M 8/04746; H01M 8/04537

(52) U.S. Cl. CPC H01M 8/0656; H01M 2250/20; H01M 8/04619; H01M 8/04753

(57) ABSTRACT

An electric power adjustment system includes: a power storage system that is configured to store electric power; a reversible fuel cell system that is configured to generate electric power through a chemical reaction in a fuel cell using hydrogen which is supplied from a hydrogen station configured to store hydrogen and supply the generated electric power to the power storage system and that is configured to produce hydrogen through water electrolysis in the fuel cell and supply the produced hydrogen to the hydrogen station; a power adjustment device that is configured to adjust a flow of electric power which is exchanged between the power storage system and the reversible fuel cell system; and a power management device that is configured to manage the flow of electric power in the power adjustment device.

### CROSS-REFERENCE TO RELATED APPLICATION

This application claims priority to and the benefit from Japanese Patent Application No. 2020-098562, filed Jun. 5, 2020, the contents of which are hereby incorporated by reference into the present application.

### BACKGROUND

### Field of the Invention

The present invention relates to an electric power adjustment system, an electric power adjustment method, and a storage medium.

### Description of Related Art

Recently, power-to-gas (P2G) approaches have been progressing. P2G employs a structure for producing hydrogen using electric power of renewable energy and storing and using the produced hydrogen. The stored hydrogen may be, for example, hydrogen which is supplied from a hydrogen supply source or hydrogen which is produced by electrolyzing water using electric power supplied from a power supply source such as a photovoltaic system or a wind power generator.

As a technique of producing hydrogen, there is a cogeneration system using a reversible fuel cell (for example, Japanese Unexamined Patent Application, First Publication No. 2003-100312, which is hereinafter referred to as Patent Document 1). This system is a system that flexibly supplies electric power and heat to an existing primary power generation facility using at least two fuel-cell power generation devices which are reversibly usable.

In the system disclosed in Patent Document 1, a decrease in cost for producing hydrogen can be achieved by producing hydrogen using midnight electric power. However, since the produced hydrogen gas is merely used, for example, for a secondary fuel-cell power generation device, it cannot be said that the produced hydrogen is effectively utilized.

### SUMMARY

The present invention was made in consideration of the aforementioned circumstances and an objective thereof is to provide an electric power adjustment system, an electric power adjustment method, and a storage medium that can effectively utilize produced hydrogen.

An electric power adjustment system, an electric power adjustment method, and a storage medium according to the present invention employ the following configurations.

(1) According to an aspect of the present invention, there is provided an electric power adjustment system including: a power storage system that is configured to store electric power; a reversible fuel cell system that is configured to generate electric power through a chemical reaction in a fuel cell using hydrogen which is supplied from a hydrogen station configured to store hydrogen and supply the generated electric power to the power storage system and that is configured to produce hydrogen through water electrolysis in the fuel cell and supply the produced hydrogen to the hydrogen station; a power adjustment device that is configured to adjust a flow of electric power which is exchanged between the power storage system and the reversible fuel cell system; and a power management device that is configured to manage the flow of electric power in the power adjustment device.

(2) In the aspect of (1), the power management device may determine whether the reversible fuel cell system is to generate electric power or to produce hydrogen.

(3) In the aspect of (1), the hydrogen station may include: a pressure boost system that is configured to boost a pressure of hydrogen; and a hydrogen tank that is configured to store hydrogen, and hydrogen which is supplied from the reversible fuel cell system to the hydrogen station may be boosted in pressure by the pressure boost system and stored in the hydrogen tank.

(4) In the aspect of (3), the pressure boost system may include a PEM membrane pump that is configured to boost the pressure of hydrogen.

(5) In the aspect of (1), the reversible fuel cell system may include a fuel cell that is configured to generate electric power through a chemical reaction using hydrogen and produces hydrogen through water electrolysis.

(6) In the aspect of (1), the reversible fuel cell system may include: a power generation system that is configured to generate electric power through a chemical reaction using hydrogen; and a water electrolysis system that is configured to produce hydrogen through water electrolysis.

(7) The electric power adjustment system according to the aspect of (1) may further include a power supply source that is configured to generate electric power with supplied natural energy and supply the generated electric power to the hydrogen station, and the hydrogen station may further include a water electrolysis system that is configured to produce hydrogen through water electrolysis using electric power supplied from the power supply source.

(8) In the aspect of (2), the power management device may include: an acquirer configured to acquire at least one of a state of a request for an amount of electric power in the power management device and a state of a request for an amount of hydrogen in the hydrogen station; and a determiner configured to determine whether the reversible fuel cell system is to generate electric power or to produce hydrogen on the basis of at least one of the state of the request for the amount of electric power and the state of the request for the amount of hydrogen which are acquired by the acquirer.

(9) In the aspect of (8), the determiner may determine that the reversible fuel cell system is to produce hydrogen in a case where the state of the request for the amount of electric power in the power management device indicates a request to decrease the amount of electric power.

(10) In the aspect of (8), the determiner may determine that the reversible fuel cell system is to generate electric power in a case where the state of the request for the amount of electric power in the power management device indicates a request to increase the amount of electric power.

(11) In the aspect of (1), the determiner may determine that the reversible fuel cell system is to produce hydrogen in a case where the state of the request for the amount of hydrogen in the hydrogen station indicates a request to increase the amount of hydrogen.

(12) In the aspect of (1), the determiner may determine that the reversible fuel cell system is to generate electric power in a case where the state of the request for the amount of hydrogen in the hydrogen station indicates a request to decrease the amount of hydrogen.

(13) In the aspect of (8), the acquirer may acquire a hydrogen price and an electric power price in a market, and the determiner may determine whether the reversible fuel cell system is to generate electric power or to produce hydrogen on the basis of a result of comparison between a profit which is acquired in a case where the reversible fuel cell system produces hydrogen and a profit which is acquired in a case where the reversible fuel cell system generates electric power.

(14) In the aspect of (8), the determiner may determine whether the reversible fuel cell system is to generate electric power according to a daily change of the amount of residual electric power.

(15) The electric power adjustment system according to the aspect of (8) may further include an adjuster configured to adjust the amount of generated electric power and the amount of produced hydrogen in the reversible fuel cell system on the basis of at least one of the state of the request for the amount of electric power and the state of the request for the amount of hydrogen which are acquired by the acquirer.

(16) In the aspect of (15), the adjuster may adjust the amount of generated electric power in the reversible fuel cell system to become greater as a profit acquired in a case where the reversible fuel cell system generates electric power becomes greater.

(17) In the aspect of (10, the adjuster may adjust the amount of produced hydrogen in the reversible fuel cell system to become greater as a profit acquired in a case where the reversible fuel cell system produces hydrogen becomes greater.

(18) In the aspect of (8), the state of the request for the amount of electric power may be calculated on the basis of an electric power demand which is output from a trained model acquired through machine learning.

(19) The electric power adjustment system according to the aspect of (1) may further include a generator configured to generate the trained model using machine learning.

(20) According to another aspect of the present invention, there is provided an electric power adjustment method which is performed by the power management device in the electric power adjustment system according to the aspect of (8), the electric power adjustment method including: acquiring at least one of a state of a request for the amount of electric power in the power management device and a state of a request for the amount of hydrogen in the hydrogen station; and determining whether the reversible fuel cell system is to generate electric power or to produce hydrogen on the basis of the acquired at least one of the state of the request for the amount of electric power and the state of the request for the amount of hydrogen.

(21) According to another aspect of the present invention, there is provided a non-transitory computer-readable storage medium that is configured to store a program for causing the power management device in the electric power adjustment system according to the aspect of (8) to perform: acquiring at least one of a state of a request for the amount of electric power in the power management device and a state of a request for the amount of hydrogen in the hydrogen station; and determining whether the reversible fuel cell system is to generate electric power or to produce hydrogen on the basis of the acquired at least one of the state of the request for the amount of electric power and the state of the request for the amount of hydrogen.

According to the aspects of (1) to (21), it is possible to effectively utilize produced hydrogen.

### BRIEF DESCRIPTION OF THE DRAWINGS

FIG. 1 is a diagram showing an example of a configuration of an electric power adjustment system according to a first embodiment.

FIG. 2 is a diagram showing an example of a configuration of a reversible fuel cell system.

FIG. 3 is a flowchart showing an example of a process which is performed by a power management device.

FIG. 4 is a flowchart showing an example of a process which is performed by the power management device.

FIG. 5 is a flowchart showing an example of a process which is performed by the power management device.

FIG. 6 is a flowchart showing an example of a process which is performed by the power management device.

FIG. 7 is a flowchart showing an example of a process which is performed by the power management device.

FIG. 8 is a flowchart showing an example of a process which is performed by the power management device.

FIG. 9 is a diagram showing an example of a configuration of an electric power adjustment system according to a second embodiment.

FIG. 10 is a diagram conceptually showing a function of a first trained model.

FIG. 11 is a diagram conceptually showing a function of a second trained model.

### DETAILED DESCRIPTION OF THE INVENTION

Hereinafter, embodiments of an electric power adjustment system, an electric power adjustment method, and a storage medium according to the present invention will be described with reference to the accompanying drawings.

### First Embodiment

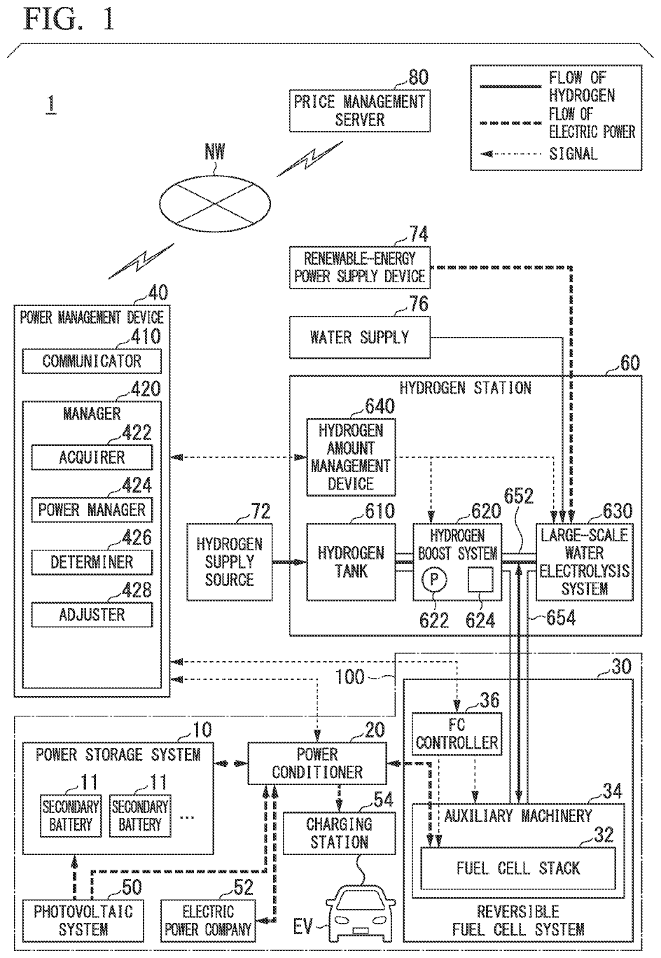

FIG. 1 is a diagram showing an example of a configuration of an electric power adjustment system 1 according to a first embodiment. The electric power adjustment system 1 includes, for example, a power storage system 10, a power conditioner 20, a reversible fuel cell system 30, and a power management device 40. Among these, the power storage system 10, the power conditioner 20, and the reversible fuel cell system 30 are included in a virtual power plant (hereinafter referred to as “VPP”) 100. The power management device 40 manages electric power which is exchanged in the VPP 100. The VPP 100 further includes a photovoltaic system 50, an electric power company 52, and a charging device 54.

The photovoltaic system 50 is connected to the power storage system 10 and the power conditioner 20. The photovoltaic system 50 is configured to supply generated electric power to the power storage system 10 and the power conditioner 20. The power conditioner 20 can exchange electric power with the electric power company 52 and supply electric power to the charging device 54. The reversible fuel cell system 30 exchanges electric power with a hydrogen station 60.

The power storage system 10 includes, for example, a plurality of secondary batteries 11, 11, . . . . Each secondary battery 11 is, for example, a lithium-ion battery. The secondary battery 11 may be another rechargeable battery. For example, a battery mounted in a vehicle may be secondarily used as the secondary battery 11. The secondary battery 11 is provided to an owner who owns the photovoltaic system 50.

The power storage system 10 stores electric power which is supplied from the power conditioner 20 or the photovoltaic system 50. The power storage system 10 discharges the stored electric power or stores the electric power which is supplied from the power conditioner 20 or the photovoltaic system 50 according to adjustment of electric power in the power conditioner 20.

The power conditioner 20 can exchange electric power with the power storage system 10 and the reversible fuel cell system 30. The power conditioner 20 adjusts a flow of electric power which is exchanged between the power storage system 10 and the reversible fuel cell system 30. The power conditioner 20 receives electric power supplied from the photovoltaic system 50. The power conditioner 20 exchanges electric power with the electric power company 52. The power conditioner 20 supplies electric power to the charging device 54. The power conditioner 20 is an example of a power adjustment device.

The power conditioner 20 adjusts an amount of electric power which is output from the power storage system 10, which is exchanged with the reversible fuel cell system 30 and the electric power company 52, and which is supplied to the charging device 54 on the basis of adjustment information which is transmitted from the power management device 40. For example, the power conditioner 20 adjusts the amount of electric power supplied to the power storage system 10 and the amount of electric power supplied to the power conditioner 20 out of electric power which is generated by the photovoltaic system 50. The power conditioner 20 adjusts a voltage according to a supply destination.

The power conditioner 20 acquires amounts of electric power which can be adjusted by the power conditioner 20 such as the amount of electric power stored in the power storage system 10, the amount of electric power generated by the photovoltaic system 50, the amount of electric power exchanged with the electric power company 52, and the amount of electric power supplied to the charging device 54. The power conditioner 20 generates total electric power amount information on the basis of the amounts of electric power which can be adjusted by the power conditioner 20 and the total amount thereof. The power conditioner 20 transmits the generated total electric power amount information to the power management device 40.

The reversible fuel cell system 30 includes, for example, a fuel cell stack 32, auxiliary machinery 34, and a fuel cell controller (hereinafter referred to as an “FC controller”) 36. The reversible fuel cell system 30 generates electric power through chemical reactions in the fuel cell stack 32 using hydrogen supplied from the hydrogen station 60, supplies the generated electric power to the power storage system 10, produces hydrogen through water electrolysis in the fuel cell stack 32, and supplies the produced hydrogen to the hydrogen station 60.

The fuel cell stack 32 generates electric power through chemical reactions using hydrogen and produces hydrogen through water electrolysis. The fuel cell stack 32 operates in one of several operation modes including a power generation mode in which electric power is generated and a water electrolysis mode in which hydrogen is produced. The FC controller 36 controls the auxiliary machinery 34 such that the fuel cell stack 32 operates in a predetermined operation mode.

The fuel cell stack 32 generates electric power by causing hydrogen supplied from the hydrogen station 60 and oxygen introduced from the atmospheric air to react chemically when the operation mode is the power generation mode. The fuel cell stack 32 is an example of a fuel cell. The fuel cell stack 32 produces hydrogen by electrolyzing deionized water using electric power supplied from the power conditioner 20 when the operation mode is the water electrolysis mode. Water which is used for water electrolysis may not be deionized water but may be, for example, tap water.

The auxiliary machinery 34 is provided to cool the fuel cell stack 32 or to introduce electric power and deionized water into the fuel cell stack 32. The auxiliary machinery 34 switches electric power and deionized water which are supplied to the fuel cell stack 32 by causing pumps or valves to operate according to the operation mode under the control of the FC controller 36. For example, the fuel cell stack 32 may be a product which is manufactured for a power generation system or may be a renewal product which has been mounted in a fuel cell vehicle. The fuel cell stack 32 may include a plurality of small fuel cell stacks and generate electric power or produce hydrogen using all the small fuel cell stacks. When the fuel cell stack 32 includes a plurality of small fuel cell stacks, the fuel cell stacks may be for different uses including, for example, small fuel cell stacks for power generation and small fuel cell stacks for hydrogen production.

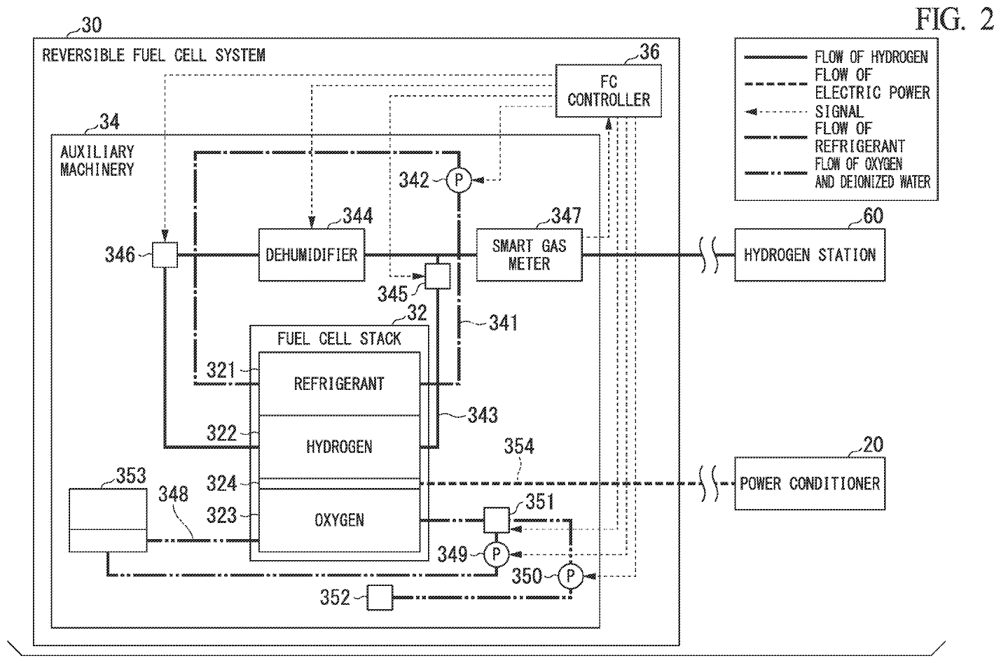

Details of the fuel cell stack 32 and the auxiliary machinery 34 will be described below. FIG. 2 is a diagram showing an example of a configuration of the reversible fuel cell system 30. The fuel cell stack 32 includes, for example, a refrigerant unit 321, a hydrogen unit 322, an oxygen unit 323, and a membrane-electrode assembly (hereinafter referred to as an “MEA”) 324. The auxiliary machinery 34 includes, for example, a refrigerant flow passage 341, a refrigerant pump 342, a hydrogen flow passage 343, a dehumidifier 344, a check valve 345, a three-way valve 346, a smart gas meter 347, a gas/liquid flow passage 348, a deionized water pump 349, an air pump 350, a switch valve 351, an air filter 352, a deionized water tank 353, and a power line 354.

A refrigerant is circulated and supplied to the refrigerant unit 321 via the refrigerant flow passage 341. When the refrigerant is circulated and supplied to the refrigerant unit 321, the whole fuel cell stack 32 is cooled. When the operation mode of the fuel cell stack 32 is the power generation mode, the hydrogen unit 322 serves as a place into which hydrogen supplied from the hydrogen station 60 flows. When the operation mode of the fuel cell stack 32 is the water electrolysis mode, the hydrogen unit 322 serves as a place in which hydrogen is produced.

When the operation mode of the fuel cell stack 32 is the power generation mode, the oxygen unit 323 serves as a place in which oxygen flows. When the operation mode of the fuel cell stack 32 is the water electrolysis mode, the oxygen unit 323 serves as a place in which deionized water flows. When the operation mode of the fuel cell stack 32 is the power generation mode, the MEA 324 generates electric power through chemical reactions between hydrogen in the hydrogen unit 322 and oxygen in the oxygen unit 323. When the operation mode of the fuel cell stack 32 is the water electrolysis mode, the MEA 324 electrolyzes the deionized water flowing in the oxygen unit 323 using electric power supplied from the power conditioner 20 and produces hydrogen in the hydrogen unit 322.

The refrigerant flow passage 341 is connected to the refrigerant unit 321 and the refrigerant pump 342 is provided in the refrigerant flow passage 341. The refrigerant pump 342 operates or stops its operation on the basis of a drive signal which is transmitted from the FC controller 36. When the refrigerant pump 342 operates, a refrigerant circulates in the refrigerant flow passage 341 and the refrigerant unit 321 is supplied with the refrigerant while the refrigerant is being circulated. When the refrigerant pump 342 stops, circulation of the refrigerant in the refrigerant flow passage 341 is stopped and circulation and supply of the refrigerant to the refrigerant unit 321 are stopped.

The hydrogen flow passage 343 is connected to the hydrogen unit 322. The dehumidifier 344, the check valve 345, and the three-way valve 346 are provided in the hydrogen flow passage 343. The dehumidifier 344 operates or stops its operation on the basis of a mode control signal which is transmitted from the FC controller 36. When the dehumidifier 344 operates, hydrogen in the hydrogen flow passage 343 is dehumidified.

The check valve 345 and the three-way valve 346 are opened and closed on the basis of the mode control signal transmitted from the FC controller 36. When the check valve 345 and the three-way valve 346 are opened and closed, a flow direction of hydrogen in the hydrogen flow passage 343 and an auxiliary machine to and from which hydrogen can flow via the hydrogen flow passage 343 from and to the hydrogen unit 322 are changed.

The smart gas meter 347 is provided in the hydrogen flow passage 343. The smart gas meter 347 detects a flow rate of hydrogen flowing in the hydrogen flow passage 343. The amount of hydrogen which is exchanged between the hydrogen station 60 and the reversible fuel cell system 30 is calculated on the basis of a result of detection from the smart gas meter 347. The smart gas meter 347 transmits a flow rate signal indicating a detected flow rate of hydrogen to the FC controller 36.

The gas/liquid flow passage 348 is connected to the oxygen unit 323. The deionized water pump 349, the air pump 350, the switch valve 351, and the air filter 352 are provided in the gas/liquid flow passage 348. The deionized water pump 349, the air pump 350, and the switch valve 351 operate or stop their operations on the basis of the mode control signal which is transmitted from the FC controller 36.

When the fuel cell stack 32 is in the power generation mode, the air pump 350 operates to introduce air into the oxygen unit 323. The switch valve 351 is controlled to a position at which air can flow between an air introducer and the oxygen unit 323 and the air filter 352 is provided. When the air pump 350 operates, air is introduced into the gas/liquid flow passage 348 via the air filter 352 and the air is introduced into the oxygen unit 323 without any change.

When the fuel cell stack 32 is in the water electrolysis mode, the deionized water pump 349 operates to introduce deionized water into the oxygen unit 323. The switch valve 351 is controlled to a position at which deionized water can flow between a deionized water discharger in the deionized water tank 353 and the oxygen unit 323. When the deionized water pump 349 operates, deionized water is introduced into the gas/liquid flow passage 348 via the deionized water tank 353 and the deionized water flows in the oxygen unit 323 and returns to the deionized water tank 353 without any change.

The deionized water tank 353 stores deionized water. The deionized water tank 353 circulates and supplies deionized water to the gas/liquid flow passage 348 when the deionized water pump 349 operates. A water sealer or an oxygen separator that removes oxygen from deionized water may be provided in the deionized water tank 353.

The power line 354 is provided between the MEA 324 and the power conditioner 20. When the fuel cell stack 32 is in the power generation mode, electric power is supplied from the MEA 324 to the power conditioner 20 via the power line 354. When the fuel cell stack 32 is in the water electrolysis mode, electric power is supplied from the power conditioner 20 to the MEA 324 via the power line 354.

The FC controller 36 is realized, for example, by causing a hardware processor such as a central processing unit (CPU) to execute a program (software). Some or all of constituents thereof may be realized by hardware (a circuit unit which includes circuitry) such as a large scale integration (LSI) circuit, an application-specific integrated circuit (ASIC), a field-programmable gate array (FPGA), or a graphics processing unit (GPU) or may be realized by combination of software and hardware. The program may be stored in a storage device (a storage device including a non-transitory storage medium) such as a hard disk drive (HDD) or a flash memory in advance or may be stored in a removable storage medium (a non-transitory storage medium) such as a CD-ROM and installed in a storage device by setting the storage medium to a drive device.

The FC controller 36 sets the operation mode of the fuel cell stack 32 on the basis of determination information transmitted from the power management device 40. The determination information includes power generation information when it is determined that the reversible fuel cell system 30 is to generate electric power and hydrogen production information when it is determined that the reversible fuel cell system 30 is to produce hydrogen. When the power generation information transmitted from the power management device 40 is received, the FC controller 36 generates a power generation mode signal as a mode control signal and outputs the generated power generation mode signal to the auxiliary machinery 34. When the hydrogen production information is received, the FC controller 36 generates a water electrolysis mode signal as a mode control signal and outputs the generated water electrolysis mode signal to the auxiliary machinery 34.

The power management device 40 manages a flow of electric power which is exchanged between the power storage system 10 and the reversible fuel cell system 30. The power management device 40 includes, for example, a communicator 410 and a manager 420. The manager 420 includes, for example, an acquirer 422, a power manager 424, a determiner 426, and an adjuster 428. The acquirer 422, the power manager 424, the determiner 426, and the adjuster 428 are realized, for example, by causing a hardware processor such as a CPU to execute a program (software). Some or all of these constituents may be realized by hardware such as an LSI circuit, an ASIC, an FPGA, or a GPU or may be realized by combination of software and hardware. The program may be stored in a storage device such as an HDD or a flash memory in advance or may be stored in a removable storage medium such as a DVD or a CD-ROM and installed in a storage device by setting the storage medium to a drive device.

The communicator 410 is a radio communication module that receives various types of information which are transmitted from the power conditioner 20, the hydrogen station 60, and a price management server 80. The communicator 410 receives, for example, hydrogen request state information transmitted from the hydrogen station 60 and price information transmitted from the price management server 80.

The acquirer 422 acquires various types of information which are received by the communicator 410. The acquirer 422 notifies the determiner 426 and the adjuster 428 of the hydrogen request state information out of various types of acquired information and notifies the power manager 424 of the other information. The total amount of electric power required for the VPP 100 is calculated on the basis of the price information and the like received by the communicator 410. The power manager 424 compares the calculated total amount of electric power with total electric power amount information received by the communicator 410 and calculates a state of a request for an amount of electric power of the VPP 100. The power manager 424 generates electric power request state information on the basis of the calculated state of the request for the amount of electric power. The electric power request state information includes required electric power amount information, electric power amount increase request information, and electric power amount decrease request information.

The required electric power amount information indicates an amount of electric power to be added as an amount of electric power of the VPP 100. Examples of the amount of electric power which is added to the amount of electric power of the VPP 100 include the amount of electric power generated by the photovoltaic system 50, the amount of electric power purchased from the electric power company 52, and the amount of electric power generated by the reversible fuel cell system 30. The electric power amount increase request information is information which is generated when the total amount of electric power indicated by the total electric power amount information received by the communicator 410 is less than the total amount of electric power required for the VPP 100. The electric power amount decrease request information is information which is generated when the total amount of electric power indicated by the total electric power amount information received by the communicator 410 is equal to or greater than the total amount of electric power required for the VPP 100. The power manager 424 notifies the determiner 426 and the adjuster 428 of the generated electric power request state information.

The determiner 426 determines the operation mode of the reversible fuel cell system 30 on the basis of the electric power request state information calculated by the power manager 424 and the hydrogen request state information acquired by the acquirer 422. The determiner 426 generates determination information on the basis of the determined operation mode. The determiner 426 notifies the adjuster 428 of the generated determination information. The determiner 426 transmits the generated determination information to the reversible fuel cell system 30 using the communicator 410.

The adjuster 428 determines whether the reversible fuel cell system 30 is to generate electric power or to produce hydrogen on the basis of the determination information notified by the determiner 426. The adjuster 428 adjusts the amount of generated electric power and the amount of produced hydrogen of the reversible fuel cell system 30 on the basis of the electric power request state information calculated by the power manager 424 and the hydrogen request state information acquired by the acquirer 422.

When it is determined that the reversible fuel cell system 30 is to generate electric power, the adjuster 428 includes the amount of generated electric power of the reversible fuel cell system 30 in the total electric power amount information. The adjuster 428 generates adjustment information indicating exchange of electric power in the power conditioner 20 on the basis of the total electric power amount information and the electric power request state information. The adjuster 428 generates adjustment information and generates produced hydrogen amount information indicating the amount of produced hydrogen of the reversible fuel cell system 30. The adjuster 428 transmits the generated adjustment information and the generated produced hydrogen amount information to the power conditioner 20 and a hydrogen amount management device 640 using the communicator 410.

The photovoltaic system 50 includes, for example, a solar cell module (a solar panel) and a photovoltaic power conditioner. The solar cell module may be provided at any place, for example, the solar cell module may be provided in the vicinity of a position at which the secondary batteries 11 are provided. An owner of the photovoltaic system 50 may be, for example, an owner of the secondary batteries 11. For example, the photovoltaic system 50 may be transferred or rented to the owner of the secondary batteries 11.

In the photovoltaic system 50, the solar cell module receives light such as sunlight and generates electric power, and the photovoltaic power conditioner adjusts the voltage. The photovoltaic system 50 supplies electric power with the adjusted voltage to the power storage system 10 or the power conditioner 20 with adjustment of the power conditioner 20. The photovoltaic power conditioner is provided separately from the power conditioner 20, but the power conditioner 20 may also serve as the photovoltaic power conditioner.

The electric power company 52 exchanges electric power with the power conditioner 20. For example, the electric power company 52 buys and sells electric power from and to a manager of the electric power adjustment system 1. The power conditioner 20 exchanges electric power with the electric power company 52 on the basis of results of buying and selling.

The charging device 54 charges an electric vehicle EV or the like. For example, the charging device 54 is provided in a charging station. The power conditioner 20 supplies electric power to the charging device 54 in response to a request from the charging device 54. The charging device 54 receives electric power supplied from the power conditioner 20 and charges an electric vehicle EV. The charging device 54 is provided in a charging station herein, but may be provided a multi-family house, a detached house, an office building, or the like.

The hydrogen station 60 includes, for example, a hydrogen tank 610, a hydrogen boost system 620, a large-scale water electrolysis system 630, and a hydrogen amount management device 640. The hydrogen station 60 stores hydrogen. The hydrogen tank 610 is a tank that stores compressed hydrogen. The hydrogen tank 610 stores hydrogen which has been transported from a hydrogen supply source 72 via a land route or a sea route and hydrogen which has been boosted by the hydrogen boost system 620.

The hydrogen boost system 620 boosts a pressure of hydrogen which is produced by the large-scale water electrolysis system 630 and the reversible fuel cell system 30 and stores the hydrogen tank 610 with the boosted hydrogen. A first hydrogen passage 652 in which hydrogen flows is connected between the hydrogen boost system 620 and the large-scale water electrolysis system 630, and a second hydrogen passage 654 is connected between the first hydrogen passage 652 and the reversible fuel cell system 30. The second hydrogen passage 654 is a low/middle-pressure hydrogen passage, and hydrogen produced by the reversible fuel cell system 30 is supplied to the hydrogen boost system 620 at a minimum pressure required for pipeline transportation, for example, at a middle supply pressure of 0.1 [MpaG] to 0.3 [MpaG]. The hydrogen supplied at a middle pressure from the reversible fuel cell system 30 is boosted in pressure by the hydrogen boost system 620 and is stored in the hydrogen tank 610. For example, the reversible fuel cell system 30 supplies the produced hydrogen to the hydrogen boost system 620 via the second hydrogen passage 654 and the first hydrogen passage 652 without accumulating the hydrogen.

The hydrogen boost system 620 includes a PEM membrane pump 622 and a humidification/dehumidification device 624. The hydrogen boost system 620 humidifies or dehumidifies hydrogen using the humidification/dehumidification device 624 in boosting the pressure of the hydrogen using the PEM membrane pump 622. The hydrogen boost system 620 performs a pre-humidification process before humidifying hydrogen and performs a post-dehumidification process after dehumidifying hydrogen. In this case, a concentration of a residual moisture in hydrogen which is supplied from the reversible fuel cell system 30 to the hydrogen station 60 may be appropriately relaxed. The invention is not limited thereto when a mechanism pressure boost pump is used as the PEM membrane pump 622.

The large-scale water electrolysis system 630 produces hydrogen, for example, through water electrolysis using electric power which is supplied from a renewable-energy power supply device 74 and tap water which is supplied from a water supply 76. The large-scale water electrolysis system 630 supplies the produced hydrogen to the hydrogen boost system 620 via the first hydrogen passage 652. The first hydrogen passage 652 is a low/middle-pressure hydrogen passage similarly to the second hydrogen passage 654. The large-scale water electrolysis system 630 supplies hydrogen at a low/middle pressure to the hydrogen boost system 620. The large-scale water electrolysis system 630 is an example of a water electrolysis system.

The renewable-energy power supply device 74 includes, for example, a facility that receives natural energy and generates electric power such as a hydroelectric power generation facility, a photovoltaic facility, or a wind power generation facility. Electric power supplied from the renewable-energy power supply device 74 is, for example, so-called renewable-energy electric power, and may be other fossil-energy electric power. The renewable-energy power supply device 74 is an example of a power supply source.

The price management server 80 is, for example, a server that manages product prices including a hydrogen price and an electric power price in a market. The price management server 80 acquires a hydrogen price and an electric power price from another server or the like via a network NW and manages the acquired prices. The price management server 80 transmits and provides information on the hydrogen price and the electric power price in the market to the power management device 40 via the network NW. The reversible fuel cell system 30, the power management device 40, and the hydrogen station 60 may transmit and receive information via the network NW.

The hydrogen amount management device 640 is realized, for example, by causing a hardware processor such as a CPU to execute a program (software). Some or all of these constituents may be realized by hardware such as an LSI circuit, an ASIC, an FPGA, or a GPU or may be realized by combination of software and hardware. The program may be stored in a storage device such as an HDD or a flash memory in advance or may be stored in a removable storage medium such as a DVD or a CD-ROM and installed in a storage device by setting the storage medium to a drive device.

The hydrogen amount management device 640 calculates a state of a request for an amount of hydrogen, for example, on the basis of an amount of hydrogen stored in the hydrogen tank 610 (hereinafter referred to as an “amount of stored hydrogen”). The hydrogen amount management device 640 sets, for example, a threshold value for an amount of hydrogen stored in the hydrogen tank 610. The hydrogen amount management device 640 generates hydrogen request state information on the basis of the amount of stored hydrogen and the threshold value.

The hydrogen request state information includes required hydrogen amount information, hydrogen amount increase request information, and hydrogen amount decrease request information. The required hydrogen amount information is information indicating an amount of hydrogen stored in the hydrogen station 60 such as an amount of hydrogen to be added. Examples of the amount of hydrogen which is added to the amount of hydrogen stored in the hydrogen station 60 include an amount of hydrogen supplied from a hydrogen supply source 72, an amount of hydrogen produced by the large-scale water electrolysis system 630, and an amount of hydrogen produced by the reversible fuel cell system 30. The hydrogen amount increase request information is information which is generated when an amount of hydrogen which can be used by the hydrogen station 60 is in a deficient state. The hydrogen amount decrease request information is information which is generated when the amount of hydrogen which can be used by the hydrogen station 60 is in an excess state (which includes a state in which there is no shortage). The hydrogen amount management device 640 generates the hydrogen amount increase request information when the amount of stored hydrogen is greater than a threshold value, and generates the hydrogen amount decrease request information when the amount of stored hydrogen is equal to or less than the threshold value. The hydrogen amount management device 640 transmits the generated hydrogen request state information to the power management device 40.

When hydrogen is supplied from the reversible fuel cell system 30, the hydrogen amount management device 640 operates the hydrogen boost system 620 by outputting an operation signal to the hydrogen boost system 620, boosts the pressure of the supplied hydrogen, and stores the hydrogen in the hydrogen tank 610. Separately, the hydrogen amount management device 640 monitors the pressure in the first hydrogen passage 652 and operates the hydrogen boost system 620 by outputting an operation signal such that the pressure is in a predetermined pressure range. When hydrogen is supplied to the reversible fuel cell system 30, the hydrogen amount management device 640 decreases the pressure of hydrogen stored in the hydrogen tank 610 and supplies the hydrogen to the reversible fuel cell system 30.

The hydrogen amount management device 640 causes the large-scale water electrolysis system 630 to produce hydrogen by outputting a production signal to the large-scale water electrolysis system 630. When the large-scale water electrolysis system 630 produces hydrogen, the hydrogen amount management device 640 operates the hydrogen boost system 620 by outputting an operation signal to the hydrogen boost system 620, boosts the pressure of the produced hydrogen, and stores the hydrogen in the hydrogen tank 610.

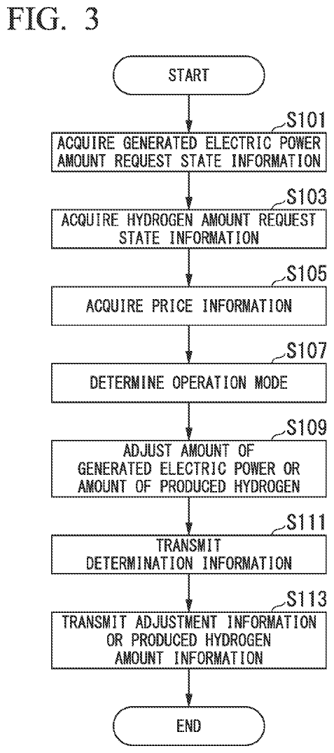

A process which is performed by the power management device 40 will be described below. FIGS. 3 to 8 are flowcharts showing an example of a process which is performed by the power management device 40.

The entire process which is performed by the power management device 40 will be described first with reference to FIG. 3. In the power management device 40, the acquirer 422 acquires generated electric power amount request information transmitted from the power conditioner 20 (Step S101). Subsequently, the acquirer 422 acquires hydrogen amount request information transmitted from the hydrogen amount management device 640 in the hydrogen station 60 (Step S103).

Subsequently, the acquirer 422 acquires price information transmitted from the price management server 80 (Step S105). Subsequently, the determiner 426 determines an operation mode of the fuel cell stack 32 when the fuel cell stack 32 operates on the basis of the generated electric power amount request information, the hydrogen amount request information, and the price information acquired by the acquirer 422 (Step S107), and generates determination information based on the determined operation mode. Subsequently, the adjuster 428 adjusts the amount of generated electric power or an amount of produced hydrogen in the reversible fuel cell system 30 (Step S109) and generates adjustment information or produced hydrogen amount information on the basis of the adjusted amount of generated electric power or the adjusted amount of produced hydrogen. A plurality of examples of the process of determining the operation mode of the fuel cell stack 32 or a plurality of examples of the process of calculating the amount of generated electric power or the amount of produced hydrogen in the reversible fuel cell system 30 will be sequentially described later.

Subsequently, the determiner 426 transmits the generated determination information to the reversible fuel cell system 30 using the communicator 410 (Step S111). For example, the determiner 426 transmits power generation information as the determination information when the determined operation mode is a power generation mode, and transmits hydrogen production information as the determination information when the determined operation mode is a water electrolysis mode. Subsequently, the determiner 426 transmits the generated adjustment information or the generated produced hydrogen amount information to the power conditioner 20 and the hydrogen amount management device 640 using the communicator 410 (Step S113). In this way, the power management device 40 ends the process shown in FIG. 3.

<First Process of Determining Operation Mode>

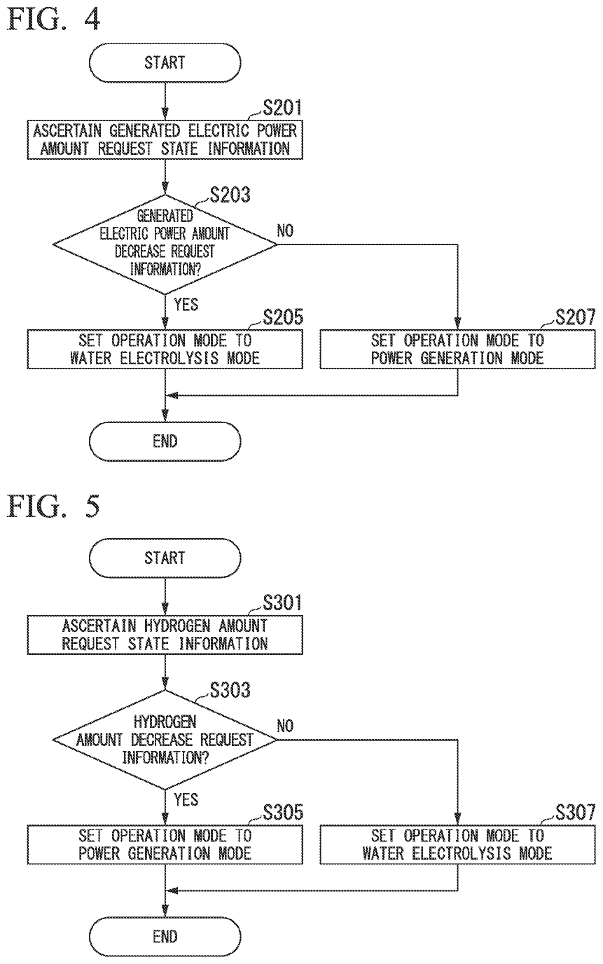

A first process of determining an operation mode will be described below with reference to FIG. 4. In determining the operation mode, the determiner 426 ascertains electric power request state information (Step S201). Subsequently, the determiner 426 determines whether the electric power request state information is electric power amount decrease request information (Step S203). When it is determined that the electric power request state information is electric power amount decrease request information, the determiner 426 sets the operation mode of the fuel cell stack 32 to the water electrolysis mode in order to cause the reversible fuel cell system 30 to produce hydrogen (Step S205).

When it is determined that the electric power request state information is not electric power amount decrease request information, the determiner 426 determines that the electric power request state information is electric power amount increase request information. In this case, the determiner 426 sets the operation mode of the fuel cell stack 32 to the power generation mode in order to cause the reversible fuel cell system 30 to generate electric power (Step S207). In this way, the power management device 40 ends the process shown in FIG. 4.

In this way, when the electric power request state information transmitted from the power conditioner 20 indicates a state of a request to decrease an amount of electric power, the amount of electric power in the VPP 100 is excessive and thus the price of electric power is low. In this case, the reversible fuel cell system 30 increases the amount of produced hydrogen using electric power with a low price in the VPP 100. On the other hand, when the electric power request state information transmitted from the power conditioner 20 indicates a state of a request to increase the amount of electric power, the reversible fuel cell system 30 generates electric power using hydrogen supplied from the hydrogen station 60 and supplies the generated electric power to the power conditioner 20.

<Second Process of Determining Operation Mode>

A second process of determining an operation mode will be described below with reference to FIG. 5. In determining the operation mode, the determiner 426 ascertains hydrogen request state information (Step S301). Subsequently, the determiner 426 determines whether the hydrogen request state information is hydrogen amount decrease request information (Step S303). When it is determined that the hydrogen request state information is hydrogen amount decrease request information, the determiner 426 sets the operation mode of the fuel cell stack 32 to the power generation mode in order to cause the reversible fuel cell system 30 to generate electric power (Step S305).

When it is determined that the hydrogen request state information is not hydrogen amount decrease request information, the determiner 426 determines that the hydrogen request state information is hydrogen amount increase request information. In this case, the determiner 426 sets the operation mode of the fuel cell stack 32 to the water electrolysis mode in order to cause the reversible fuel cell system 30 to produce hydrogen (Step S307). In this way, the power management device 40 ends the process shown in FIG. 5.

In this way, when the hydrogen request state information transmitted from the hydrogen amount management device 640 indicates a state of a request to decrease an amount of hydrogen, the amount of hydrogen stored in the hydrogen station 60 is excessive. In this case, the reversible fuel cell system 30 generates electric power using excessive hydrogen stored in the hydrogen station 60. On the other hand, when the hydrogen request state information transmitted from the hydrogen amount management device 640 indicates a state of a request to increase an amount of hydrogen, the reversible fuel cell system 30 produces hydrogen using electric power supplied from the power conditioner 20 and supplies the produced hydrogen to the hydrogen station 60.

<Third Process of Determining Operation Mode>

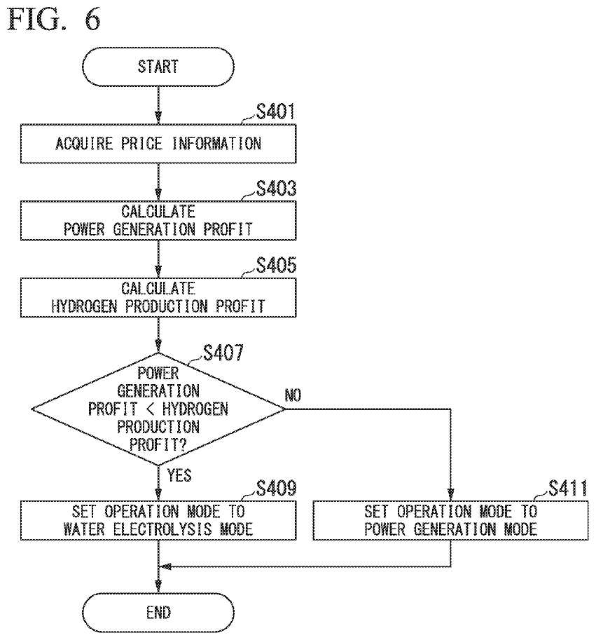

A third process of determining an operation mode will be described below with reference to FIG. 6. In determining the operation mode, the acquirer 422 acquires price information transmitted from the price management server 80 (Step S401). Subsequently, the determiner 426 calculates a profit which is obtained by causing the reversible fuel cell system 30 to generate electric power (hereinafter referred to as a “power generation profit”) on the basis of the price information acquired by the acquirer 422 (Step S403). The determiner 426 calculates the power generation profit, for example, using an electric power price included in a power generation price and a cost when the reversible fuel cell system 30 is supplied with hydrogen from the hydrogen station 60.

Subsequently, the determiner 426 calculates a profit which is obtained by causing the reversible fuel cell system 30 to produce hydrogen (hereinafter referred to as a “hydrogen production profit”) on the basis of the price information acquired by the acquirer 422 (Step S405). The determiner 426 calculates the hydrogen production profit, for example, using a hydrogen price included in the power generation price and a cost when the reversible fuel cell system 30 is supplied with electric power from the power conditioner 20.

Subsequently, the determiner 426 determines whether the power generation profit is less than the hydrogen production profit (Step S407). When it is determined that the power generation profit is less than the hydrogen production profit, the determiner 426 sets the operation mode of the fuel cell stack 32 to the water electrolysis mode (Step S409). When it is determined that the power generation profit is not less than (equal to or greater than) the hydrogen production profit, the determiner 426 sets the operation mode of the fuel cell stack 32 to the power generation mode (Step S411). In this way, the power management device 40 ends the process shown in FIG. 6.

In this way, the reversible fuel cell system 30 is caused to produce hydrogen when the power generation profit is less than the hydrogen production profit, and the reversible fuel cell system 30 is caused to generate electric power when the power generation profit is equal to or greater than the hydrogen production profit. By performing this process, a profit of a manager who manages the electric power adjustment system 1 is increased.

<Fourth Process of Determining Operation Mode>

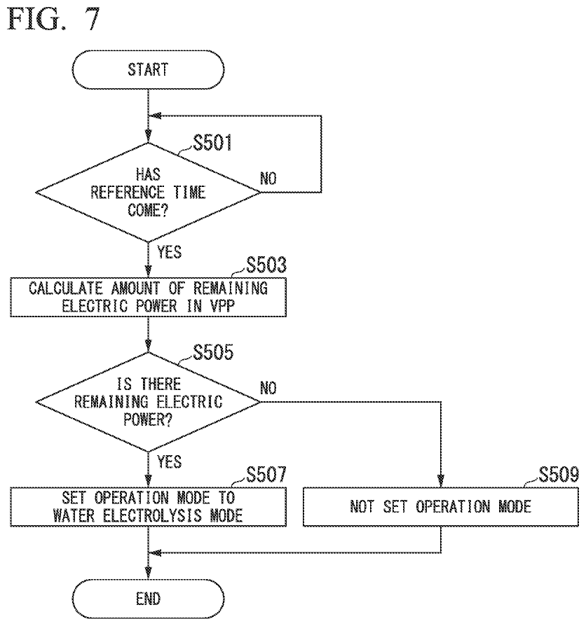

A fourth process of determining an operation mode will be described below with reference to FIG. 7. In performing the fourth process, the power management device 40 determines whether the reversible fuel cell system 30 is to generate electric power according to a daily change of an excessive amount of electric power. Accordingly, the power management device 40 stores a reference time, and the acquirer 422 acquires time information which is output from a timepiece device which is not shown. The reference time is a time serving as a daily breakpoint for calculating a daily amount of consumed electric power in the VPP 100 and is a time at which the amount of electric power remaining in the VPP 100 is measured in a day. The reference time can be set, for example, to a prescribed time such as an evening time or a night time, for example, 17 O'clock, 22 O'clock, or 0 O'clock. The reference time may be fixed in a year and may vary depending on seasons.

When the fourth process of determining the operation mode is started, the acquirer 422 determines whether the reference time has come (Step S501). When it is determined that the reference time has not come, the acquirer 422 repeatedly performs the process of Step S301 until the reference time comes. When the acquirer 422 determines that the reference time has come, the determiner 426 calculates an excessive amount of electric power in the VPP 100 using a total amount of electric power in the VPP 100 (Step S503). The excessive amount of electric power in the VPP 100 is, for example, an amount of electric power corresponding to an excess exceeding a set value close to a lower limit of an amount of stored electric power out of electric power stored in the power storage system 10. For example, when the amount of electric power stored in the power storage system 10 is equal to or less than a set value, there is no amount of electric power remaining in the VPP 100.

Subsequently, the determiner 426 determines whether there is an amount of electric power remaining in the VPP 100 (Step S505). When it is determined that there is an amount of electric power remaining in the VPP 100, the determiner 426 sets the operation mode of the fuel cell stack 32 to the water electrolysis mode in order to cause the reversible fuel cell system 30 to generate electric power (Step S507). In this way, the power management device 40 ends the process shown in FIG. 7. When it is determined in Step S505 that there is not an amount of electric power remaining in the VPP 100, the determiner 426 does not set the operation mode (Step S509) and the power management device 40 ends the process shown in FIG. 7.

In this way, according to a daily change of an excessive amount of electric power, for example, when there is excessive electric power at a time point serving as the reference time in a day, the whole electric power in the VPP 100 can be used by producing and storing hydrogen using the excessive electric power. Accordingly, it is possible to efficiently use electric power of the VPP 100. On the other hand, since an amount of hydrogen stored in the hydrogen station 60 is increased, it may be possible to generate electric power using hydrogen and to supply the generated electric power to houses, for example, at the time of disaster or emergency.

<Routine of Adjusting Amount of Generated Electric Power or Amount of Produced Hydrogen>

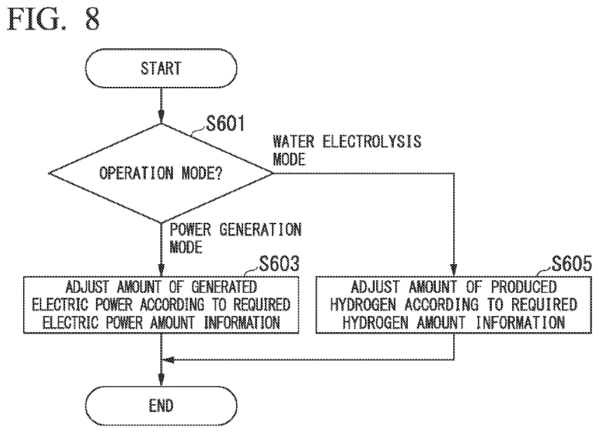

A process of adjusting an amount of generated electric power or an amount of produced hydrogen will be described below with reference to FIG. 8. In performing the process of adjusting an amount of generated electric power or an amount of produced hydrogen, the adjuster 428 determines whether the operation mode of the fuel cell stack 32 determined by the determiner 426 is the power generation mode or the water electrolysis mode (Step S601).

When it is determined that the operation mode of the fuel cell stack 32 determined by the determiner 426 is the power generation mode, the adjuster 428 adjusts an amount of generated electric power of the reversible fuel cell system 30 on the basis of required electric power amount information included in the electric power request state information acquired by the acquirer 422 (Step S603). For example, as the required amount of electric power indicated by the required electric power amount information increases, the amount of generated electric power of the reversible fuel cell system 30 is adjusted to increase. In order to adjust the amount of generated electric power of the reversible fuel cell system 30, any means may be used and, for example, a calculation expression for calculating the amount of generated electric power may be used or a table indicating an adjustment amount corresponding to the required amount of electric power may be referred to. In this way, the power management device 40 ends the process shown in FIG. 8.

When it is determined that the operation mode of the fuel cell stack 32 determined by the determiner 426 is the water electrolysis mode, the adjuster 428 adjusts an amount of produced hydrogen of the reversible fuel cell system 30 on the basis of required hydrogen amount information included in the hydrogen request state information acquired by the acquirer 422 (Step S605). For example, as the required amount of hydrogen indicated by the required hydrogen amount information increases, the amount of produced hydrogen of the reversible fuel cell system 30 is adjusted to increase. In order to adjust the amount of produced hydrogen of the reversible fuel cell system 30, any means may be used and, for example, a calculation expression for calculating the amount of produced hydrogen may be used or a table indicating an adjustment amount corresponding to the required amount of hydrogen may be referred to. In this way, the power management device 40 ends the process shown in FIG. 8.

In the electric power adjustment system 1 according to the first embodiment, the reversible fuel cell system 30 supplies electric power, which is generated through a chemical reaction in the fuel cell stack 32 using hydrogen supplied from the hydrogen station 60, to the power storage system 10 and supplies hydrogen, which is produced through water electrolysis in the fuel cell stack 32, to the hydrogen station 60. In the electric power adjustment system 1 according to the first embodiment, the power management device 40 manages a flow of electric power in the power conditioner 20 that adjusts a flow of electric power which is exchanged between the power storage system 10 and the reversible fuel cell system 30. Accordingly, it is possible to effectively utilize hydrogen which is produced by the reversible fuel cell system 30.

### Second Embodiment

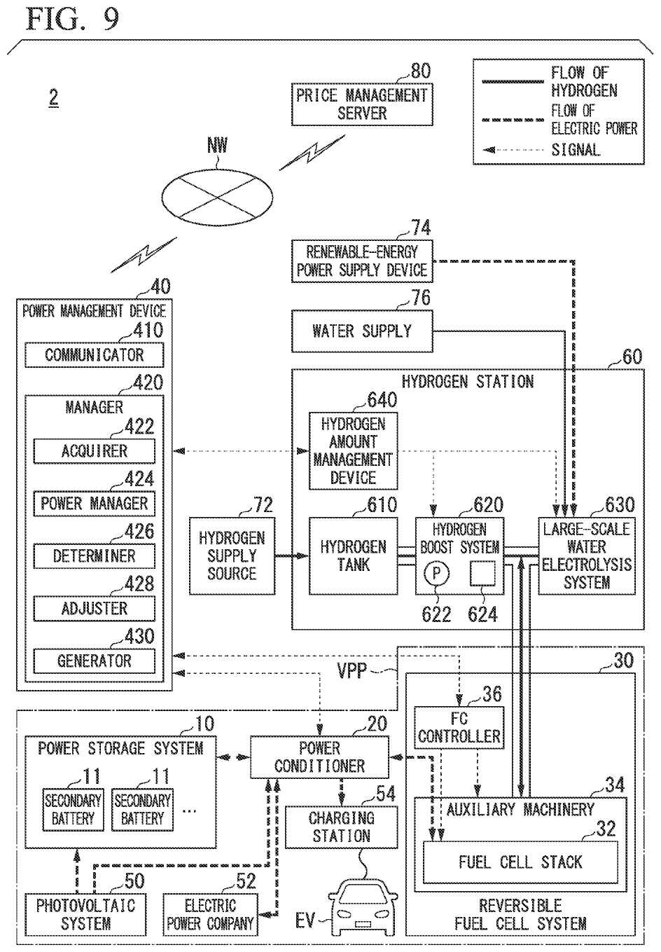

FIG. 9 is a diagram showing an example of a configuration of an electric power adjustment system 2 according to a second embodiment. The electric power adjustment system 2 according to the second embodiment is different from the electric power adjustment system 1 according to the first embodiment in the configuration of the power management device 40. The other configurations are the same as in the first embodiment. Description of the same functions or configurations in the second embodiment as in the first embodiment will be appropriately omitted.

In the electric power adjustment system 2 according to the second embodiment, the power management device 40 includes a generator 430. The generator 430 generates a first trained model which is acquired through machine learning with an amount of electric power generated in the photovoltaic system 50, an electric power price, a variation history of power consumption, and the like as input data and with an electric power demand in the VPP 100 as output data. The generator 430 generates a second trained model which is acquired through machine learning with a required amount of electric power, a required amount of hydrogen, or the like as input data and with an amount of generated electric power and an amount of produced hydrogen of the reversible fuel cell system 30 as output data. For example, supervised learning such as a support vector machine (SVM), a decision tree, deep learning, or a k-nearest neighbor (k-nn) classifier or unsupervised learning is used as the machine learning.

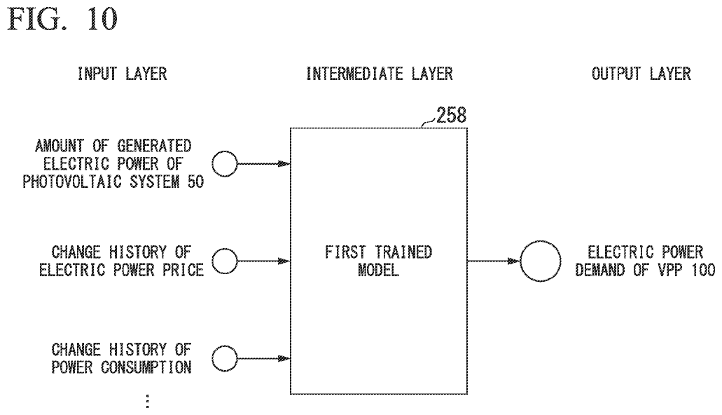

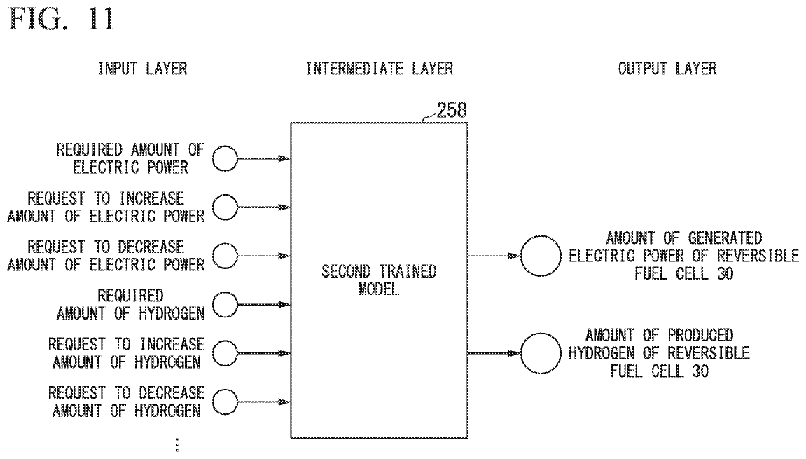

FIG. 10 is a diagram conceptually showing a function of the first trained model and FIG. 11 is a diagram conceptually showing a function of the second trained model. The first trained model and the second trained model include, for example, an input layer, an intermediate layer, and an output layer. For example, data such as an amount of generated electric power of the photovoltaic system 50, an electric power price, and a variation history of power consumption is input to the input layer of the first trained model. An electric power demand of the VPP 100 is output from the output layer of the first trained model. For example, data such as a required amount of electric power, an electric power amount increase request, an electric power amount decrease request, a required amount of hydrogen, a hydrogen amount increase request, and a hydrogen amount decrease request which are acquired by the acquirer 422 is input to the input layer of the second trained model. The amount of generated electric power and an amount of produced hydrogen of the reversible fuel cell system 30 are output from the output layer of the second trained model. The intermediate layer includes, for example, a multi-layered neural network connecting the input layer and the output layer.

The determiner 426 predicts an electric power demand of the VPP 100 using the first trained model generated by the generator 430 and calculates a required amount of electric power on the basis of the electric power demand of the VPP 100. The adjuster 428 calculates the amount of generated electric power and the amount of produced hydrogen of the reversible fuel cell system 30 using the first trained model generated by the generator 430. The adjuster 428 generates adjustment information or produced hydrogen amount information based on the calculated amount of generated electric power and the calculated amount of produced hydrogen of the reversible fuel cell system 30. The adjuster 428 transmits the generated adjustment information or the produced hydrogen amount information to the reversible fuel cell system 30 using the communicator 410.

The electric power adjustment system 2 according to the second embodiment achieves the same operations and advantages as those of the electric power adjustment system according to the first embodiment. The electric power adjustment system 2 according to the second embodiment calculates the required amount of electric power of the VPP and the amount of generated electric power and the amount of produced hydrogen of the reversible fuel cell system 30 using a trained model obtained through machine learning. Accordingly, it is possible to appropriately set the amount of generated electric power and the amount of produced hydrogen of the reversible fuel cell system 30. In the second embodiment, the electric power demand is predicted using machine learning, but a hydrogen demand may be predicted instead of or in addition to the electric power demand In the second embodiment, block chain technology may be used as a security measure. According to the second embodiment, it is possible to sell electric power or hydrogen such that a high profit can be obtained, for example, by predicting the electric power demand or the hydrogen demand

In the aforementioned embodiments, the photovoltaic system 50 is included in the VPP 100, but a large-scale energy farm in which the power storage system 10 and wind power generation are combined may be included therein in addition to the photovoltaic system 50. For example, the large-scale energy farm may be sold to users in lots or may be leased in long terms. The manager of the electric power adjustment system 1 may sell or lease the power storage system 10 to an owner who has already owned the photovoltaic system 50 and may cause the owner to use the power storage system along with the large-scale energy farm. For example, the manager of the electric power adjustment system 1 can invest a profit obtained by selling or leasing the power storage system 10 in facilities in the VPP 100 or partially use the profit to secure land.

While embodiments of the present invention have been described above, the invention is not limited to the embodiments and can be subjected to various modifications and substitutions without departing from the gist of the invention.

What is claimed is:

1. An electric power adjustment system comprising:
a power storage system that is configured to store electric power;
a reversible fuel cell system that is configured to generate electric power through a chemical reaction in a fuel cell using hydrogen which is supplied from a hydrogen station configured to store hydrogen and supply the generated electric power to the power storage system and that is configured to produce hydrogen through water electrolysis in the fuel cell and supply the produced hydrogen to the hydrogen station;
a power adjustment device that is configured to adjust a flow of electric power which is exchanged between the power storage system and the reversible fuel cell system; and
a power management device that is configured to manage the flow of electric power in the power adjustment device.

2. The electric power adjustment system according to claim 1, wherein the power management device is configured to determine whether the reversible fuel cell system is to generate electric power or to produce hydrogen.

3. The electric power adjustment system according to claim 1, wherein the hydrogen station includes:
a pressure boost system that is configured to boost a pressure of hydrogen; and
a hydrogen tank that is configured to store hydrogen, and
wherein hydrogen which is supplied from the reversible fuel cell system to the hydrogen station is boosted in pressure by the pressure boost system and stored in the hydrogen tank.

4. The electric power adjustment system according to claim 3, wherein the pressure boost system includes a PEM membrane pump that is configured to boost the pressure of hydrogen.

5. The electric power adjustment system according to claim 1, wherein the reversible fuel cell system includes a fuel cell that is configured to generate electric power through a chemical reaction using hydrogen and produce hydrogen through water electrolysis.

6. The electric power adjustment system according to claim 1, wherein the reversible fuel cell system includes:
a power generation system that is configured to generate electric power through a chemical reaction using hydrogen; and
a water electrolysis system that is configured to produce hydrogen through water electrolysis.

7. The electric power adjustment system according to claim 1, further comprising a power supply source that is configured to generate electric power with supplied natural energy and supply the generated electric power to the hydrogen station,
wherein the hydrogen station further includes a water electrolysis system that is configured to produce hydrogen through water electrolysis using electric power supplied from the power supply source.

8. The electric power adjustment system according to claim 2, wherein the power management device includes:
an acquirer configured to acquire at least one of a state of a request for an amount of electric power in the power management device and a state of a request for an amount of hydrogen in the hydrogen station; and
a determiner configured to determine whether the reversible fuel cell system is to generate electric power or to produce hydrogen on the basis of at least one of the state of the request for the amount of electric power and the state of the request for the amount of hydrogen which are acquired by the acquirer.

9. The electric power adjustment system according to claim 8, wherein the determiner is configured to determine that the reversible fuel cell system is to produce hydrogen in a case where the state of the request for the amount of electric power in the power management device indicates a request to decrease the amount of electric power.

10. The electric power adjustment system according to claim 8, wherein the determiner is configured to determine that the reversible fuel cell system is to generate electric power in a case where the state of the request for the amount of electric power in the power management device indicates a request to increase the amount of electric power.

11. The electric power adjustment system according to claim 8, wherein the determiner is configured to determine that the reversible fuel cell system is to produce hydrogen in a case where the state of the request for the amount of hydrogen in the hydrogen station indicates a request to increase the amount of hydrogen.

12. The electric power adjustment system according to claim 8, wherein the determiner is configured to determine that the reversible fuel cell system is to generate electric power in a case where the state of the request for the amount of hydrogen in the hydrogen station indicates a request to decrease the amount of hydrogen.

13. The electric power adjustment system according to claim 8, wherein the acquirer is configured to acquire a hydrogen price and an electric power price in a market, and
wherein the determiner is configured to determine whether the reversible fuel cell system is to generate electric power or to produce hydrogen on the basis of a result of comparison between a profit which is acquired in a case where the reversible fuel cell system produces hydrogen and a profit which is acquired in a case where the reversible fuel cell system generates electric power.

14. The electric power adjustment system according to claim 8, wherein the determiner is configured to determine whether the reversible fuel cell system is to generate electric power according to a daily change of the amount of residual electric power.

15. The electric power adjustment system according to claim 8, further comprising an adjuster configured to adjust the amount of generated electric power and the amount of produced hydrogen in the reversible fuel cell system on the basis of at least one of the state of the request for the amount of electric power and the state of the request for the amount of hydrogen which are acquired by the acquirer.

16. The electric power adjustment system according to claim 15, wherein the adjuster adjusts the amount of generated electric power in the reversible fuel cell system to become greater as a profit acquired in a case where the reversible fuel cell system generates electric power becomes greater.

17. The electric power adjustment system according to claim 15, wherein the adjuster adjusts the amount of produced hydrogen in the reversible fuel cell system to become greater as a profit acquired in a case where the reversible fuel cell system produces hydrogen becomes greater.

18. The electric power adjustment system according to claim 8, wherein the state of the request for the amount of electric power is calculated on the basis of an electric power demand which is output from a trained model acquired through machine learning.

19. The electric power adjustment system according to claim 18, further comprising a generator configured to generate the trained model using machine learning.

20. An electric power adjustment method which is performed by the power management device in the electric power adjustment system according to claim 8, the electric power adjustment method comprising:
acquiring at least one of a state of a request for an amount of electric power in the power management device and a state of a request for an amount of hydrogen in the hydrogen station; and
determining whether the reversible fuel cell system is to generate electric power or to produce hydrogen on the basis of the acquired at least one of the state of the request for the amount of electric power and the state of the request for the amount of hydrogen.

21. A non-transitory computer-readable storage medium that stores a program for causing the power management device in the electric power adjustment system according to claim 8 to perform:
acquiring at least one of a state of a request for an amount of electric power in the power management device and a state of a request for an amount of hydrogen in the hydrogen station; and
determining whether the reversible fuel cell system is to generate electric power or to produce hydrogen on the basis of the acquired at least one of the state of the request for the amount of electric power and the state of the request for the amount of hydrogen.
